(19) United States
(12) Patent Application Publication
(10) Pub. No.: US 2003/0131898 A1
(43) Pub. Date: Jul. 17, 2003

(54) Method of assembling two carcass ends

(76) Inventors: Martin Andersen, Bronshoj (DK); Steen Hojrup Knudsen, Rodovre (DK)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/181,023

(22) PCT Filed: Jan. 5, 2001
(86) PCT No.: PCT/DK01/00006

(51) Int. Cl. F16L 55/18

(52) U.S. Cl. 138/97; 29/469.5; 29/525.11; 405/184.3; 405/184.1

(57) ABSTRACT

By a method for the assembly of two carcass ends (1, 3), each of which consists of common, wound profiles, the end areas of the carcass pipes' common profiles are fixed. The fixing is carried out by a punctiform deformation process, which can expediently be effected by a punching process, riveting process or screw process. After the fixing, the two carcass ends are screwed into each other. In this way a fixing and a screw connection can be effected, where there is no risk of changes in the material of which the carcass pipe consists, such as can arise e.g. if a welding process is used. Especially with the punching process, it is further achieved that there is no risk that galvanic corrosion can arise. The method is especially applicable for the assembly of e.g. end lengths of new carcass pipes, and for the repair of a carcass pipe where a piece of the carcass pipe must be removed.

The invention concerns a method of assembling a first and a second carcass end to each other.

The invention also concerns a method for the repair of a carcass pipe, where a piece of the pipe must be removed from the carcass pipe.

Carcass pipes are used as part of an armoured flexible pipe which is normally built up of several layers, which from the outer side to the inner side consist of an outer sheath, a tensile armour, a pressure armour, an inner liner and a carcass.

The construction of the individual layers (except for the carcass) will not be described in more detail here, the reason being partly that their construction is not important for the understanding of the principles of the invention, and partly that they are well-known to those familiar with the technique.

The function of the carcass pipe is primarily to ensure that the inner liner does not collapse due to differences in pressure between the inside and the outside of the inner liner.

The carcass is produced by the winding of quite strong, pre-formed (profiled) metallic strips, after which the profiles are wound so that the profiles engage with each other.

Because of the winding of the quite strong profiles, it is necessary for the profiles at the ends of the finished carcass pipes to be fixed together. The reason for this is that when a carcass pipe is cut through, the elastic energy in the outermost profiles is released so that these expand. However, this can be prevented by fixing the outermost profiles to each other.

Such a fixing is normally carried out by a weld, which is effected between the profiles. It will be obvious that such a welding gives rise to a strong heating of the profiles, which locally can result in some undesired material characteristics. Moreover, a certain risk of explosion can arise if the welding is carried out in connection with the repair of carcass pipes, which have been used for the transport of inflammable fluids.

Therefore, an object of the invention is to disclose a method by which the material characteristics of the carcass pipe are not changed due to the fixing, and whereby a repair of a carcass pipe can be carried out without any risk of explosion or the like.

The object of the invention is achieved by a method of the kind disclosed in claim 1.

In this way it thus becomes possible to assemble the carcass pipes without the use of processes which demand high temperatures, e.g. such as those required for welding.

Expedient embodiments of the method are disclosed in more detail in the claims 2-6.

In this connection it should be noted that, as disclosed in claim 4, by bringing about the punctiform deformations by a punching process, it is ensured that no galvanic corrosion arises. Moreover, there will be no risk that small foreign bodies can work their way out through the inner liner.

As mentioned, the invention also concerns a method for the repair of carcass pipes.

This method is disclosed in more detail in the preamble to claim 7, and is characterised in that overlapping, common, wound profiles are first fixed by one or more punctiform deformations on each side of that piece of the pipe which requires to be removed, after which this piece is removed and the two remaining carcass ends are screwed together.

In this way a method is provided, which can be executed without any risk under all conceivable conditions, such as in connection with carcass pipes, which have been exposed to inflammable fluids.

Further, it is ensured that no elastic energy in the wound profiles is released.

The invention will now be explained in more detail with reference to the drawing, which shows an example embodiment where the invention is illustrated in connection with the repair of a carcass pipe.

### IN THE DRAWING IS SHOWN

FIG. 1 a 1^{st} step in the process for the repair of a carcass pipe,

FIG. 2 a 2^{nd} step in the process for the repair of a carcass pipe, and

FIG. 3 a 3^{rd} step in the process for the repair of a carcass pipe.

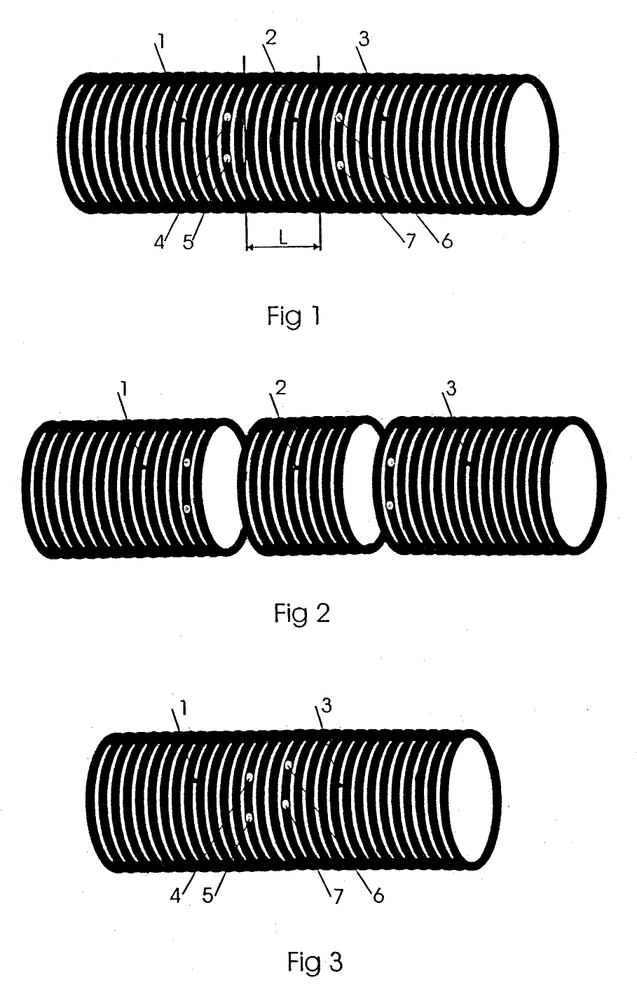

In FIG. 1 is seen a carcass pipe where 1, 2 and 3 indicate a second, a first and a third part of the carcass pipe.

This carcass pipe is of the conventional type and is produced by the profiling and winding of a metallic strip in a carcass machine.

As will be seen, the first part of the carcass pipe 2 has a length L which is required to be removed, e.g. by being sawn off, as this first part is assumed to be defective (the defect is not shown).

Before the sawing-off of the first part 2 of the carcass pipe, as shown some punctiform deformations 4,5 are carried out in the second part 1 of the carcass pipe, and some punctiform deformations 6,7 are carried out in the third part 3 of the carcass pipe. These punctiform deformations can be carried out in different ways, e.g. by a punching process, a riveting process or a screw process.

In this way, the profiles of the second and the third part of the carcass pipe are fixed to one another, so that the profiles cannot loosen themselves from their engagement later, cf. directly below.

After the punctiform deformations have been carried out, the first part 2 of the carcass pipe is cut out as shown schematically in FIG. 2, where the cutting-out has been effected. Finally, the remaining parts 1,3 of the carcass pipe are screwed together as shown schematically in FIG. 3. This screwing together is carried out in a quite normal manner.

Although the invention is explained specifically in connection with the assembly/repair of carcass pipes, there is naturally nothing to prevent the principles of the invention from being used with advantage in connection with pipes of other types, which have the same fundamental construction.

1. Method of assembling a first and a second carcass end (1,3) to each other, each carcass end comprising an overlapping, wound profile end area, where the end areas of the overlapping, common profiles of each of the carcass pipes are to be fixed, and comprising the steps of providing one or more of the wound profile end areas with one or more punctiform deformations (4,5,6,7) in the common, overlapping profiles and screwing the carcass ends together to obtain the overlapping, common profiles.

2. Method according to claim 1, characterized in that at least two punctiform deformations are effected in each profile.

3. Method according to claim 1-2, characterized in that the punctiform deformations are provided prior to the step of screwing the carcass ends together.

4. Method according to claim 1-3, characterized in that the punctiform deformations are effected by a punching process.

5. Method according to claim 1-3, characterized in that the punctiform deformations are effected by a riveting process.

6. Method according to claim 1-3, characterized in that the punctiform deformations are effected by a screw process.

7. Method for the repair of a carcass pipe, where a piece must be removed from the carcass pipe, characterized in that
on each side of that piece of the pipe, which must be removed, overlapping, common, wound profiles (1,3) are first fixed by one or more punctiform deformations (4,5,6,7), after which
the pipe piece (2) is removed, and
the two remaining ends of the carcass pipe (1,3) are screwed together.
